(19) United States
(12) Patent Application Publication
(10) Pub. No.: US 2015/0209226 A1
(43) Pub. Date: Jul. 30, 2015

(54) KIT FOR MEDICINE AND ACCESSORIES; METHODS OF USE

(71) Applicant: Apothecary Products, Inc., Burnsville, MN (US)

(72) Inventors: Robert N. Priebe, Bloomington, MN (US); Eric Russell Bombardt, Saint Paul, MN (US); Kristopher Charles Shearer, Lakeville, MN (US)

(73) Assignee: Apothecary Products, Inc., Burnsville, MN (US)

(21) Appl. No.: 14/167,029

(22) Filed: Jan. 29, 2014

(51) Int. Cl. A61J 1/03; B65D 43/22; B65D 25/28; B65D 43/16; B65D 25/04; B65D 25/54

(52) U.S. Cl. CPC A61J 1/03; B65D 25/04; B65D 25/54; B65D 25/28; B65D 43/16; B65D 43/22

(57) ABSTRACT

A kit includes a base having a storage volume, a cover removably secured to the base, and a lid removably secured over the cover and secured to the base. The cover holds at least one pill container. The storage volume can hold supplies and accessories for taking medicine.

### TECHNICAL FIELD

This disclosure relates generally to storage kits or containers. In particular, this disclosure relates to a storage kit for medicine, such as pills, and for related accessories, such as vials, pill cutters, crushers, cups, water bottles, information sheets (instructions), etc. Methods of use are provided.

### BACKGROUND

For persons who need to take medicine regularly, the need for a pill container than can be easily carried is important. A pill container that is easy to use, has sufficient capacity for the person's needs, and which can be conveniently carried by the user increases the likelihood that the user will take the correct medication at the correct time.

For some medicines, there are accessories that are needed. These accessories can include pill vials with extra pills, pill cutters, pill crushers, cups for holding water to be ingested with the pill(s), water bottles, and medicine information (schedule or instructions for taking the medicine). These accessories can be cumbersome to transport together in an organized, convenient, and secure way.

What is needed are improvements in the prior art to result in an organized, convenient, and secure manner to transport medicine and its related accessories.

### SUMMARY

A kit is provided that improves the prior art.

In general, the kit includes a base having a bottom, a surrounding wall extending from the bottom, a storage volume defined by the surrounding wall, and an opening opposite the bottom providing access to the storage volume. A cover is removably secured to the base over the opening to provide selective covering and uncovering of the storage volume in the base. The cover has a base-facing side and an opposite holder-side. The base-facing side faces the storage volume, when the cover is operably positioned in covering relation on the base, and the holder-side is facing away from the storage volume, when the cover is operably positioned in covering relation on the base. A holder-side of the cover is constructed and arranged to removably hold at least one pill container therein. A lid is removably secured over the holder-side of the cover to provide selective access to the holder-side and the at least one pill container, when the pill container is positioned therein.

Preferably, the holder-side of the cover is constructed and arranged to removably hold a plurality of pill containers therein.

Preferably, the holder-side of the cover has a depression arrangement shaped to hold at least one pill container therein.

The depression arrangement can be shaped to hold a plurality of pill containers. In one example, the depression arrangement includes at least four recessed volumes, each recessed volume being constructed and arranged to hold a respective pill container.

In preferred arrangements, the lid is transparent.

Preferably, a hinge assembly attaches the cover to the base.

Preferably, a cover snap latch arrangement selectively secures the cover to the base.

Preferably, there is a hinge assembly attaching the lid to at least one of the cover or the base.

Preferably, a lid snap latch arrangement selectively secures the lid to the cover.

In one example, the kit further includes a handle. In one example, the handle is pivotally secured to the base. For example, the handle can be pivotally secured to the surrounding wall.

In one example, a depth of the base is at least twice a depth of the cover and lid together.

In one example, the kit further includes a dividing wall arrangement in the storage volume. The dividing wall arrangement can be removable.

In example arrangements, the kit further includes at least one pill container held by the cover in the holder-side of the cover. The at least one pill container may include at least one multiple compartment container.

In a preferred arrangement, the kit includes at least four multiple compartment containers held by the cover in the holder-side of the cover, arranged in rows.

In another aspect, a method of using a kit includes unlatching a lid from a cover and pivoting the lid away from the cover to access a pill container held by the cover. There is also the step of unlatching the cover from a base and pivoting the cover from the base to access a storage volume in the base.

Preferably, after the step of pivoting the lid, there is a step of opening the pill container to access an interior of the pill container.

### BRIEF DESCRIPTION OF THE DRAWINGS

FIG. 1 is a perspective view of a kit with the lid pivoted in a position to expose the holder-side of the cover, constructed in accordance with principles of this disclosure;

FIG. 2 is a perspective view of the kit of FIG. 1, with the cover pivoted away to expose the storage volume in the base, constructed in accordance with the principles of this disclosure;

FIG. 3 is the kit of FIGS. 1 and 2, with both the lid and cover in a closed position relative to the base;

FIG. 4 is a perspective view similar to FIG. 1, but showing pill containers removed from the cover;

FIG. 5 is an exploded, perspective view of the kit of FIGS. 1-4;

FIG. 6 is a top view of the assembled kit of FIG. 5;

FIG. 7 is a front view of the kit of FIG. 6;

FIG. 8 is a rear view of the kit of FIG. 6;

FIG. 9 is a left, side view of the kit of FIG. 6;

FIG. 10 is a cross sectional view of the kit of FIG. 6, the cross section being taken along the line 10-10 of FIG. 6;

FIG. 11 is a bottom view of the kit of FIG. 6;

FIG. 12 is a perspective view of the cover used with the kit of FIGS. 1-11;

FIG. 13 is a top view of the cover of FIG. 12;

FIG. 14 is a cross sectional view of the cover of FIG. 13, the cross section being taken along the line 14-14 of FIG. 13;

FIG. 15 is a perspective view of the lid from the kit of FIGS. 1-11;

FIG. 16 is a top view of the lid of FIG. 15;

FIG. 17 is a front view of the lid of FIG. 16;

FIG. 18 is a cross sectional view of the lid of FIG. 16, the cross section being taken along the line 18-18 of FIG. 16;

FIG. 19 is a top view of the base used with the kit of FIGS. 1-11;

FIG. 20 is a rear view of the base of FIG. 19; and

FIG. 21 is a cross sectional view of the base of FIG. 19, the cross section being taken along the line 21-21 of FIG. 19.

### DETAILED DESCRIPTION

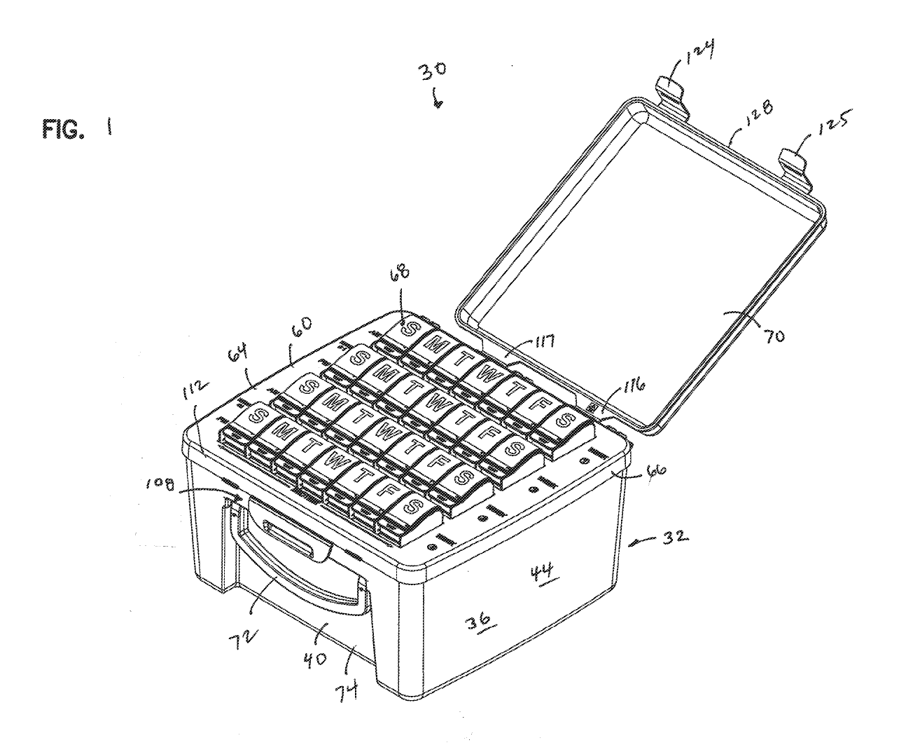

A kit is shown in FIG. 1 at reference numeral 30. The kit 30 can be useful for holding medicine, such as pills, and accessories associated with taking medicine. The accessories include things such as vials holding extra medication, pill cutters, pill crushers, cups, water bottles, syringes, and information sheets providing drug information or instructions. Of course, these are examples of accessories only, and the kit 30 can include anything that fits within it.

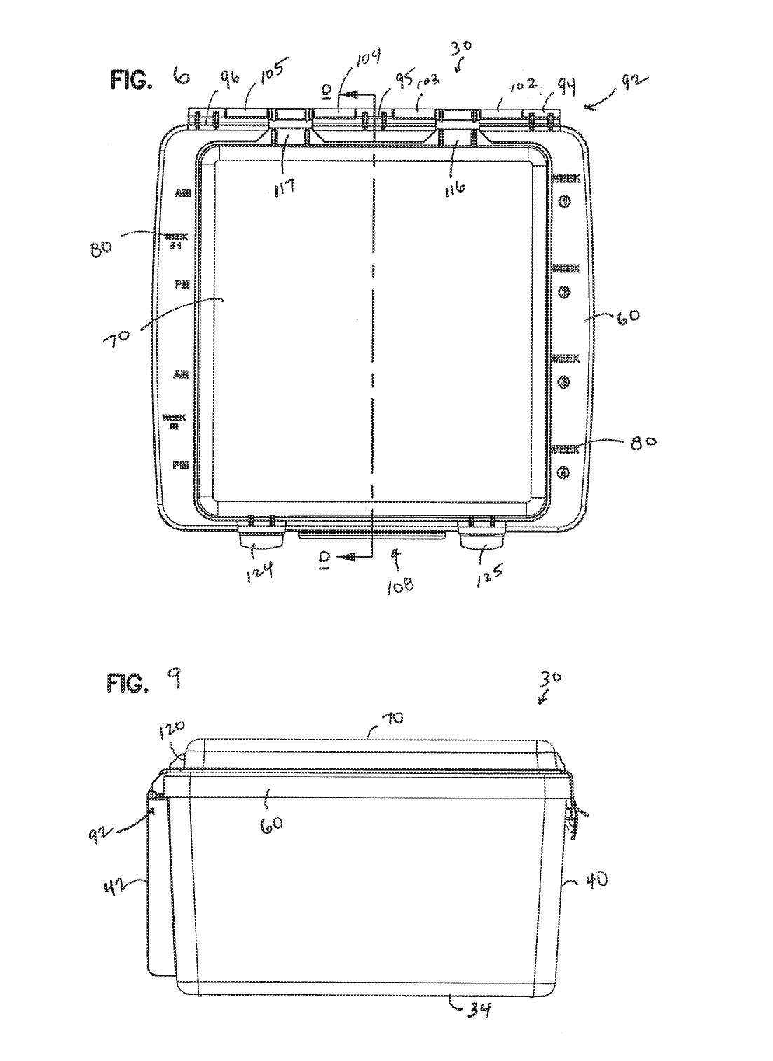

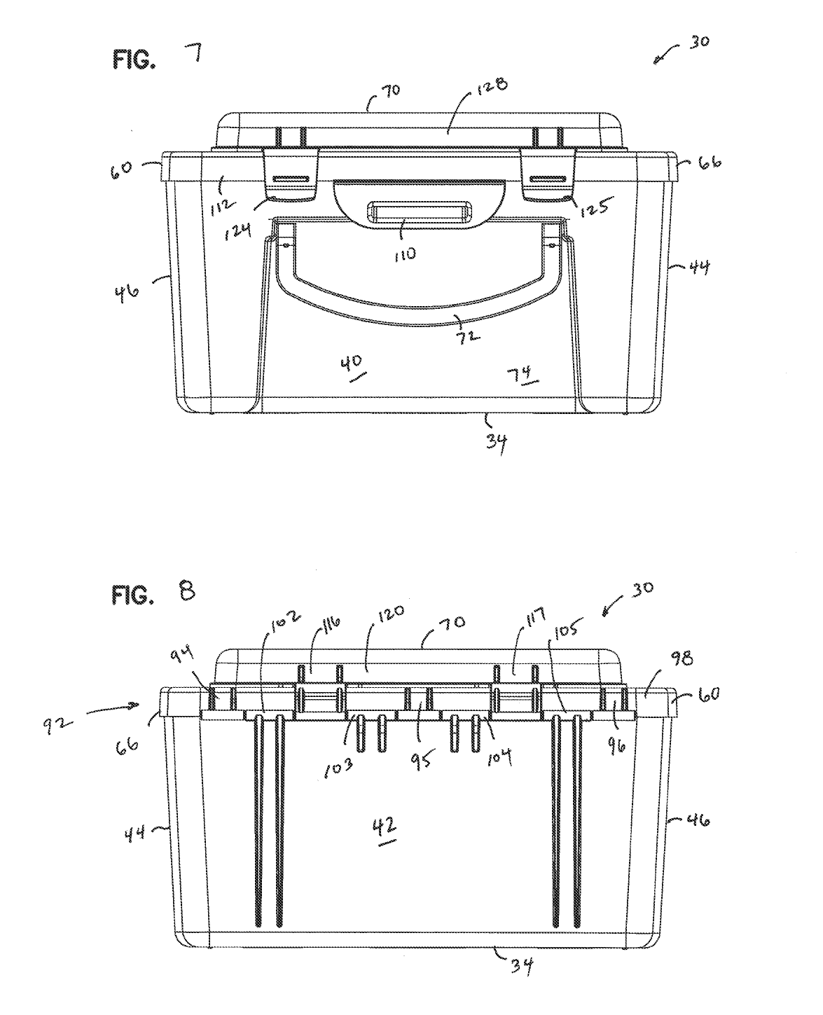

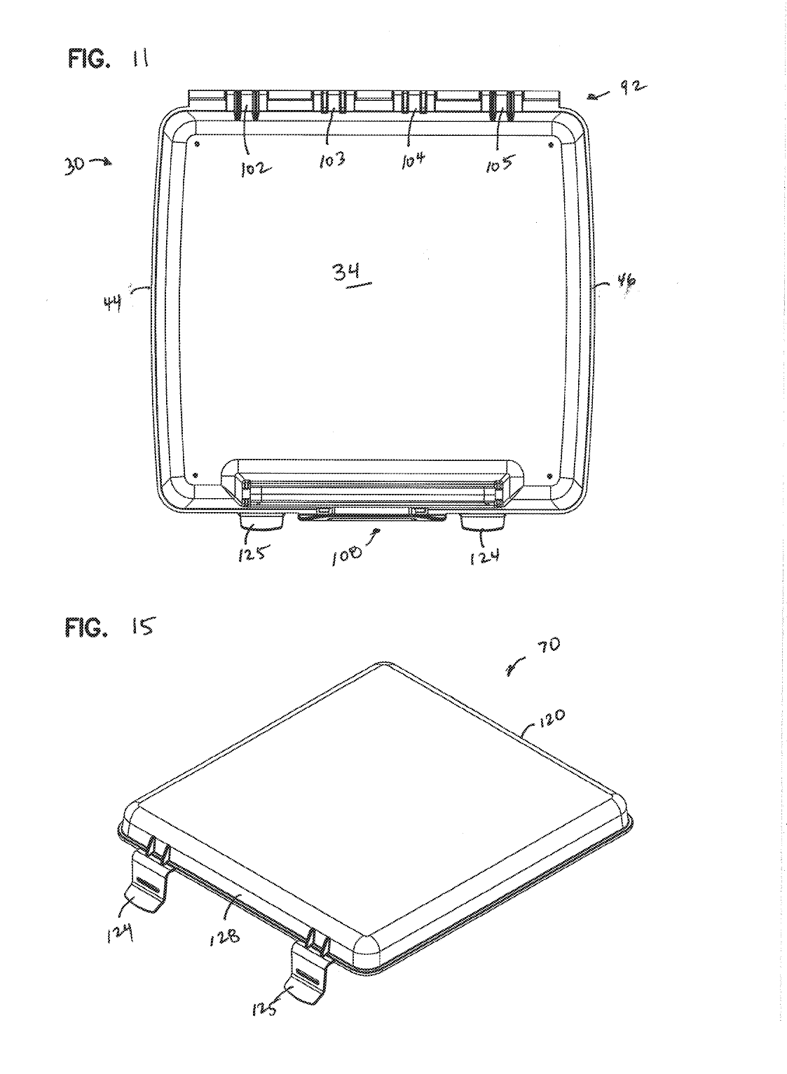

The kit 30 includes a base 32. The base 32 includes a bottom 34 (FIGS. 7-11). In general, when the kit 30 is oriented for use, the kit 30 will be placed so that the kit is resting on the bottom 34. In this example, the bottom 34 forms a generally flat resting surface.

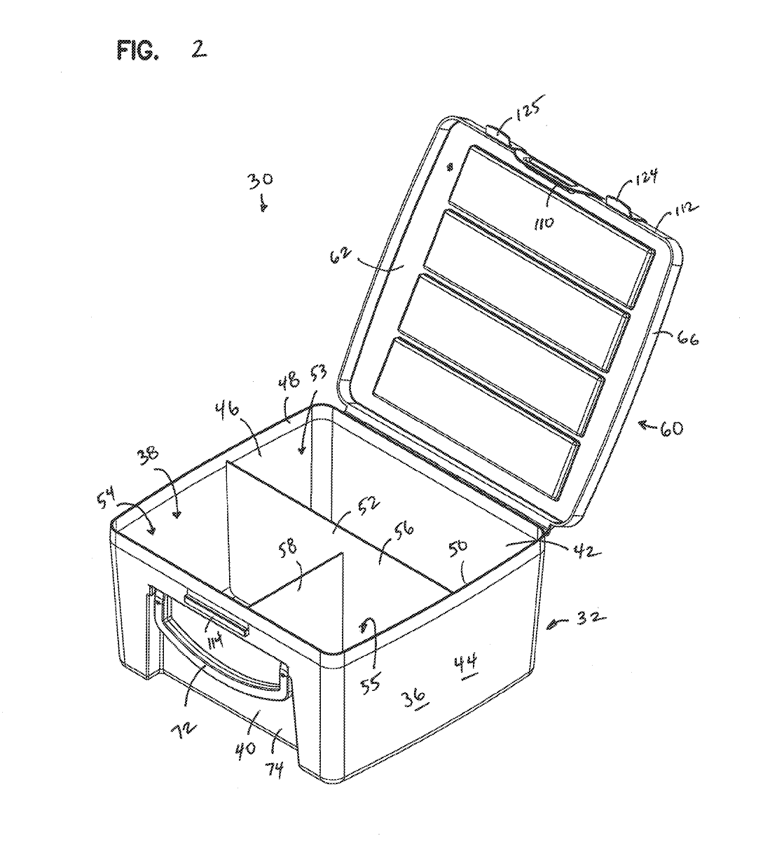

The base 32 has a surrounding wall 36 extending from the bottom 34. Together, the bottom 34 and wall 36 define a storage volume 38 (FIG. 2) therein.

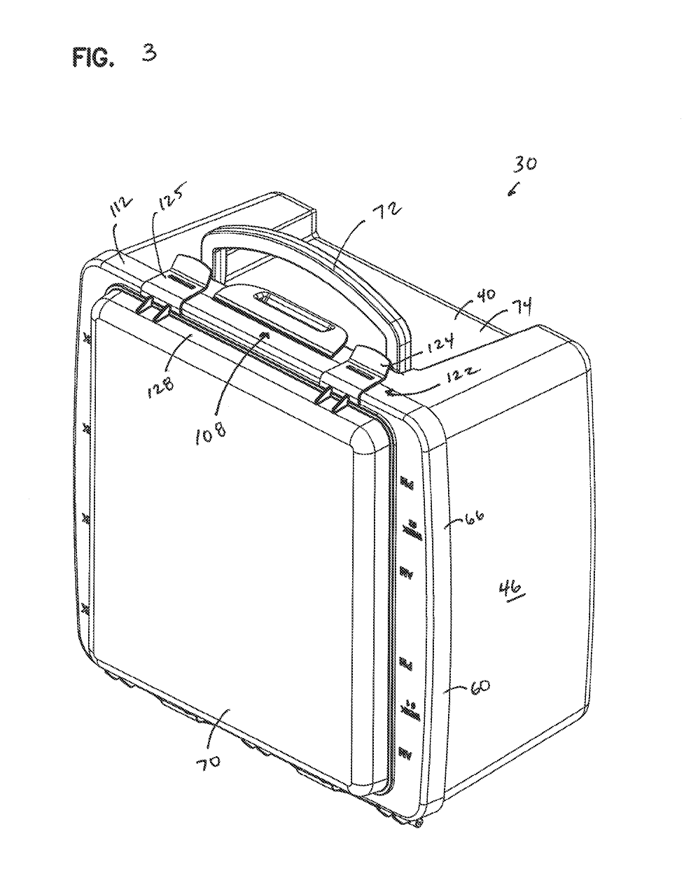

Many different shapes are possible. In the example embodiment illustrated, the base 32 is generally rectangular in shape, such that the surrounding wall 36 has a front wall 40, a rear wall 42 (FIG. 8), a first side wall 44, and a second side wall 46 (FIG. 3).

The base 32 has an opening 48 (FIG. 2) opposite the bottom 34 and providing access to the storage volume 38. In the embodiment shown, the ends of the front wall 40, rear wall 42, first side wall 44, and second side wall 46 opposite of the bottom 34 form an end rim 50 (FIG. 2) which outlines the opening 48.

In optional arrangements, the base 32 can include a dividing wall arrangement 52 in the storage volume 38. In FIG. 2, the dividing wall arrangement 52 is illustrated as an arrangement 52 that divides the volume 38 into three separate compartments 53, 54, and 55. In the example shown, the dividing wall arrangement 52 includes a wall 56 extending between the first side wall 44 and second side wall 46. The dividing wall arrangement 52 further includes, in this example, a wall 58 extending between the front wall 40 and wall 56. Of course, many different variations are possible. In many arrangements, the dividing wall arrangement 52 can be selectively removed or adjusted within the volume 38 in order to create whatever compartments and compartment sizes are desirable.

The kit 30 further includes a cover 60. The cover 60 is removably attached or secured to the base 32. In the examples shown, the cover 60 is in covering relation to the base 32. For example, the cover 60 is provided to be over the opening 48 to provide selective covering and uncovering of the storage volume 38 in the base 32. FIG. 1 shows the cover 60 operably oriented to cover the opening 48, while FIG. 2 shows the cover 60 operably oriented to be uncovering the opening 48 of the base.

The cover 60 has a base-facing side 62 (FIG. 2) and an opposite holder-side 64. The base-facing side 62 faces the storage volume 38 when the cover 60 is operably positioned in covering relation on the base 32 (FIG. 1). The holder-side 64 faces away from the storage volume 38 when the cover 60 is operably positioned in covering relation to the base 32 (FIG. 1).

The cover 60, in this example, includes a surrounding flange 66 that will form a covering around the outside of an upper portion near the rim 50 of the first and second side walls 44, 46 and front wall 40, when the cover 60 is operably positioned in covering relation the base 32.

When the cover 60 is operably positioned in covering relation on the base 32, the base-facing side 62 is positioned to generally rest against the rim 50 of the base 32.

The holder side 64 of the cover 60 has a storage volume 65 therein. The holder side 64 of the cover 60 is constructed and arranged to removably hold at least one pill container 68 in the storage volume 65.

As will be explained in further detail below, the at least one pill container 68 may be embodied in many different forms.

The kit 30 further includes a lid 70. The lid 70 is removably secured over the holder-side 64 of the cover 60 to provide selective access to the holder-side 64 and the storage volume 65. When the pill container 68 is positioned within the storage volume 65 of the cover 60, the lid 70 provides selective access to the pill container 68.

In preferred embodiments, the lid 70 is transparent. In this manner, the pill container 68 can be viewed through the lid 70, even when the lid 70 is secured and latched to the remaining portion of the kit 30. In other embodiments, the lid 70 can be opaque.

The kit 30 can further include a handle 72. The handle 72 can be secured to any portion of the kit 30 to allow for convenient and easy portability of the kit 30.

In the embodiment shown, the handle 70 is secured to the base 32. In the particular embodiment illustrated, the handle 72 is secured to the front wall 40 of the base 32. In this embodiment, the handle 72 is pivotably secured to the base 32.

As can be seen in FIG. 1, the handle 72 is mounted in a recessed portion 74 of the front wall 40. FIGS. 1 and 2 show the handle 72 in a position against the front wall 40. FIG. 3 shows the handle 72 pivoted or rotated in a direction away from the front wall 40, such that it is generally perpendicular to the front wall 40. The handle 72 is preferably sized to accommodate at least a few fingers of a person's hand in the volume between the handle 72 and the front wall 40, when the handle 72 is pivoted away from the front wall 40.

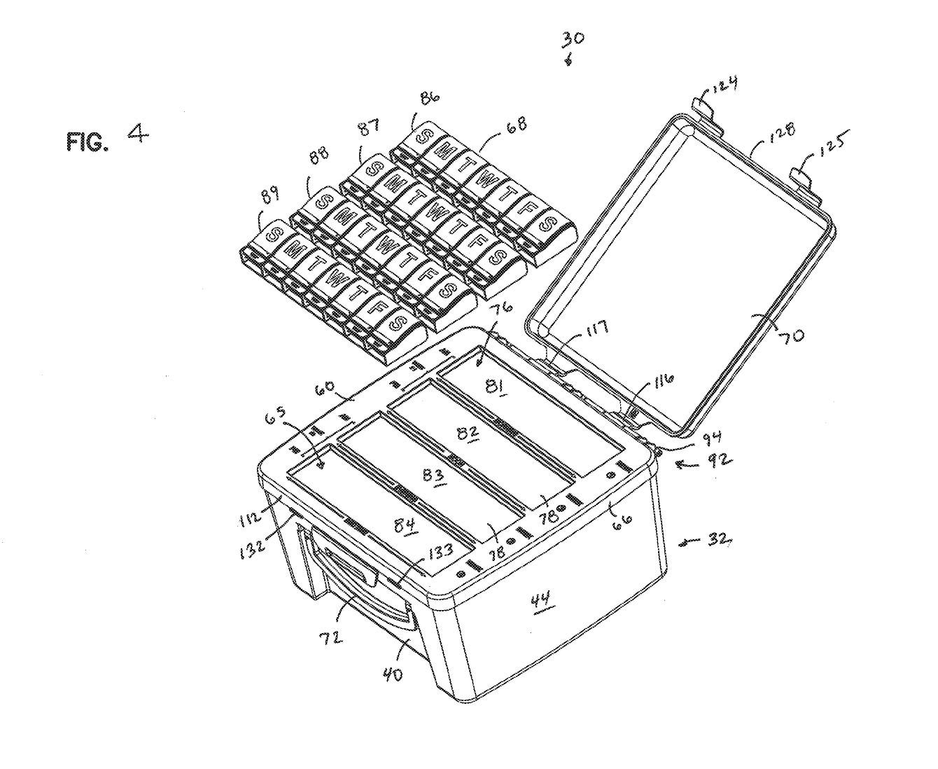

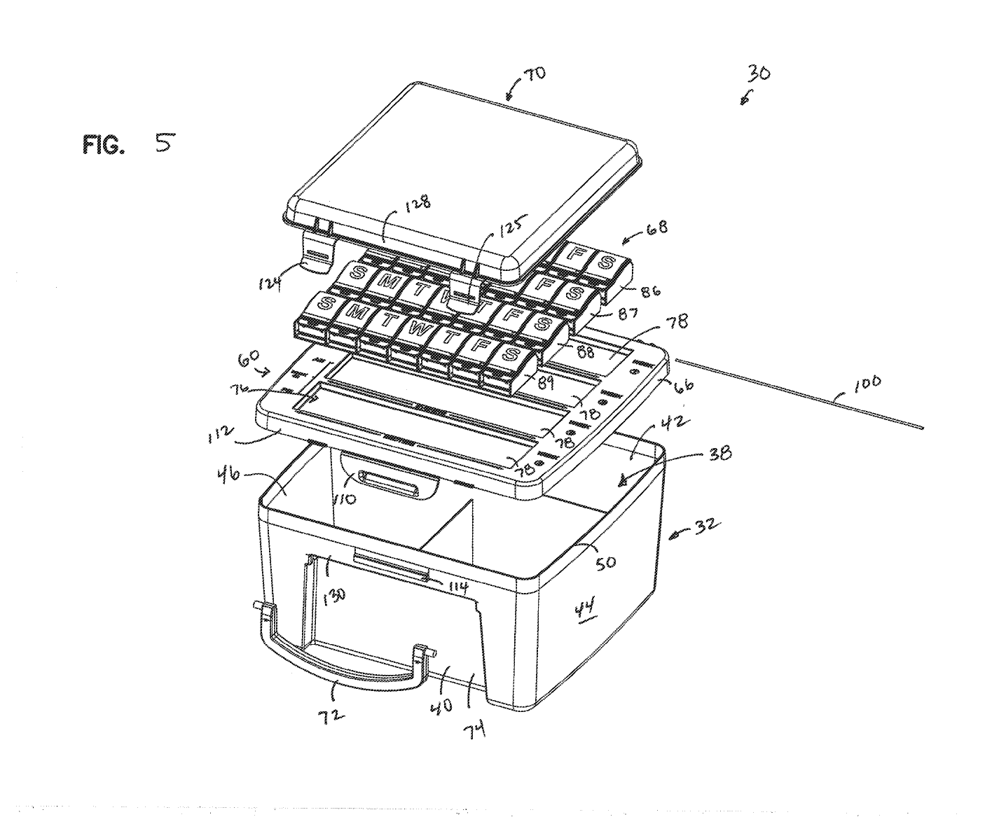

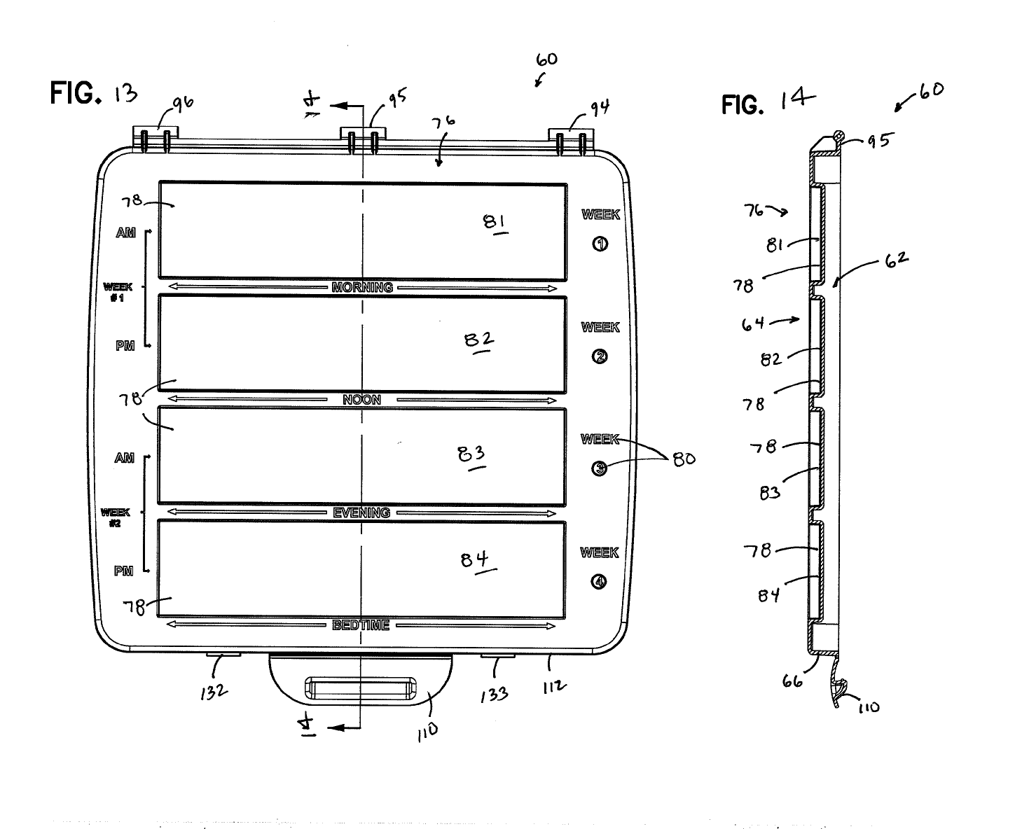

In reference now to FIGS. 4, 5, and 12-14, an embodiment of the cover 60 is described further. Preferably, the holder-side 64 of the cover 60 is constructed and arranged, or configured, to removably hold a plurality of pill containers 68 therein. In example embodiments, the holder-side 64 of the cover 60 has a depression arrangement 76 shaped to hold the one or more pill containers 68 therein. The depression arrangement 76 can be shaped to hold a single pill container 68, or a plurality of the pill containers 68. In the embodiment illustrated, the depression arrangement 76 includes at least four recessed volumes 78, with each recessed volume 78 being configured or constructed and arranged to hold one of the pill containers 68.

In this embodiment, the recessed volumes 78 are arranged in four rows. The holder-side 64 can also include written indicia 80 adjacent to the recessed volumes 78. For example, each recessed volume 78 can represent one week, with the weeks being indicated along the right-hand side. As an alternative, along the left-hand side, the top two volumes 78 can represent one week of pills, with the top row 81 being indicated for morning use, and the next adjacent row, the second row 82, being indicated for evening use for Week 1. The third row can be morning use of Week 2, while the fourth row 84 can be indicated as evening use for Week 2. Other indicia can indicate rows used for morning, noon, evening, and bedtime use.

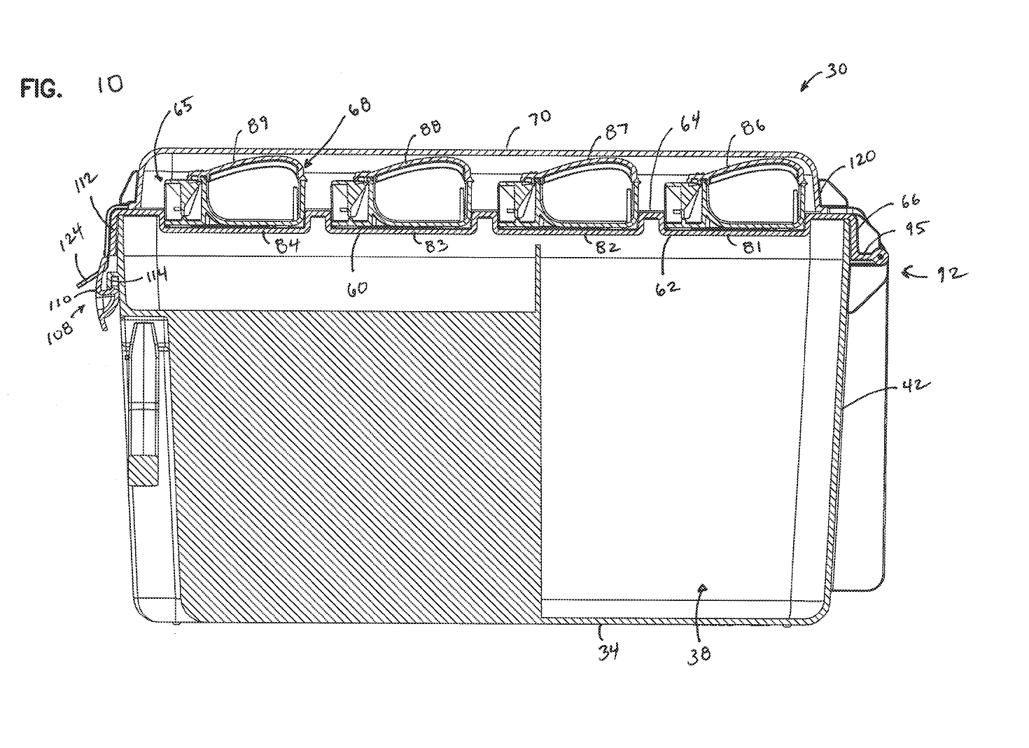

In FIGS. 1 and 10, the cover 60 is shown holding the at least one pill container 68. In particular, the cover 60 is shown holding four pill containers 68.

The pill container 68 can be any type of pill container useful for the user. In the example shown, the pill container 68 includes four multiple compartment containers 86, 87, 88, and 89. The multiple compartment containers 86-89, in this embodiment, have seven individual compartments, with each compartment having a pill storage volume accessible by an individual compartment lid. In this example, each compartment is marked with the first letter of the day of the week. The multiple compartment containers can be those as described in commonly assigned U.S. Pat. No. 7,624,890, incorporated herein by reference.

As can be seen in the FIGS., each multiple compartment container 86-89 can be removably positioned within one of the recessed volumes 78 in the rows 81-84. As such, in the embodiment shown, there are four multiple compartment containers 86, 87, 88, 89 held by the cover 60 in the holder-side 64 of the cover 60, arranged in rows 81, 82, 83, 84.

The kit 30 further includes a hinge assembly 92. The hinge assembly 92 can attach the cover 60 to the hingedly-connected or pivotally-connected to the base 32. As such, the cover 60 can be pivoted or rotated about the hinge assembly 92 toward or away from the base 32.

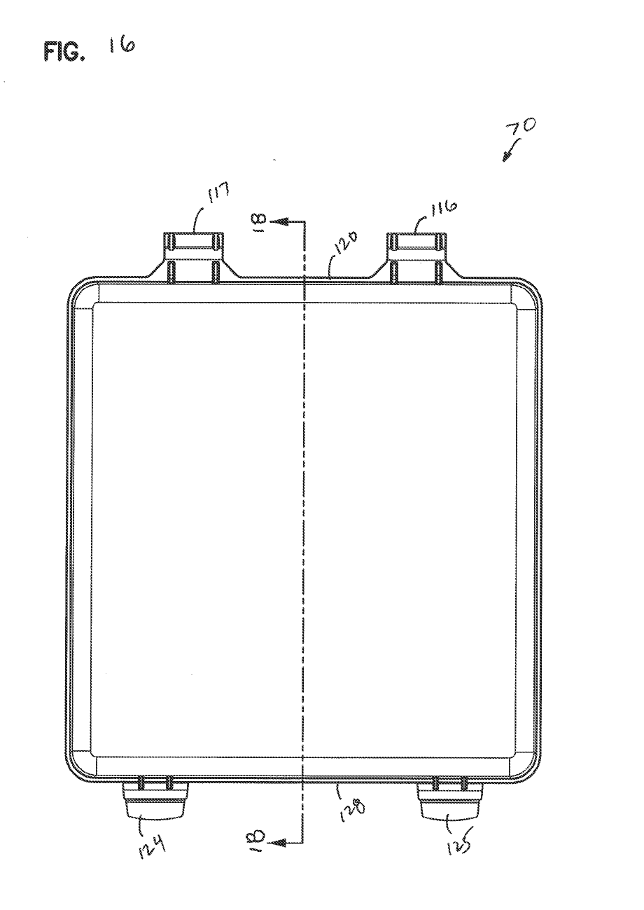

In this embodiment, and in reference now to FIGS. 5, 8, and 12-15, the hinge assembly 92 includes three hinge members 94, 95, and 96 extending from the rear side 98 of the cover 60. A hinge pin 100 (FIG. 5) connects the hinge members 94-96 to the base 32 by way of hinge members 102, 103, 104, and 105 extending from the rear wall 42 of the base 32.

The kit 30 can further include a cover snap latch arrangement 108. The cover snap latch arrangement 108 is constructed and arranged to selectively secure the cover 60 to the base 32.

In the embodiment shown, the cover snap latch arrangement 108 includes a snap latch flange 110 extending or projecting from a front side 112 of the cover 60. The flange 110 engages a latch element 114 extending or projecting from the front wall 40 of the base 32.

In the embodiment shown, the latch element 114 is located between the handle 72 and the rim 50 of the opening 48. The flange 110 selectively engages in a snap engagement with the latch element 114 so that the cover 60 can be selectively latched and unlatched from engagement with the base 32. Of course, other systems of securing the cover 60 to the base 32 are possible.

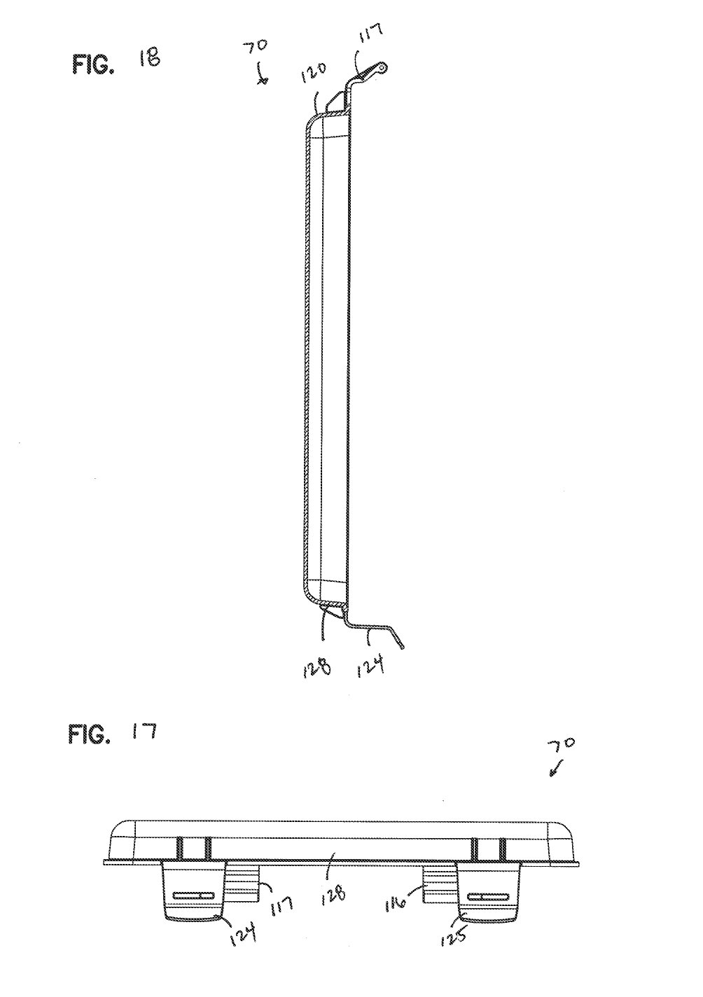

In reference now to FIGS. 16-18, an example embodiment of the lid 70 is illustrated. The lid 70, as mentioned previously, is preferably transparent to allow visibility of the contents of the cover 60, for example the pill containers 68. As can be seen in the FIGS., the lid 70 generally has the same perimeter shape as the perimeter shape of the cover 60 and base 32. In this embodiment, the shape is generally rectangular.

The hinge assembly 92 can be used to attach the lid 70 to a remaining portion of the kit 30. The lid 70 can be pivotally connected to one of the cover 60 or the base 32. In this embodiment, the hinge assembly 92 is used to attach the lid 70 to the base 32. In the example shown, the lid 70 includes a pair of hinge members 116, 117 projecting or extending from a rear side 120 of the lid 70. The hinge members 116, 117 are secured as part of the hinge assembly 92 with the hinge pin 100 (FIG. 5). In this manner, the lid 70 can pivot or hinge about the hinge assembly 92 in a direction toward and away from the remaining portion of the kit 30, including the cover 60 and base 32. Further, when the lid 70 is in a closed and covering position secured to the cover 60, the lid 70 can pivot together with the cover 60 about the hinge assembly 92 in a direction toward and from the base 32.

The kit 30 further includes a lid snap latch arrangement 122 (FIG. 3). The lid snap latch arrangement 122 selectively secures the lid 70 to the cover 60. As such, the lid 70 can be pivoted about the hinge assembly 92 in a direction toward and away from the cover 60, and when the lid 70 is operably positioned over the cover 60, it can be secured or latched in place using the lid snap latch arrangement 122.

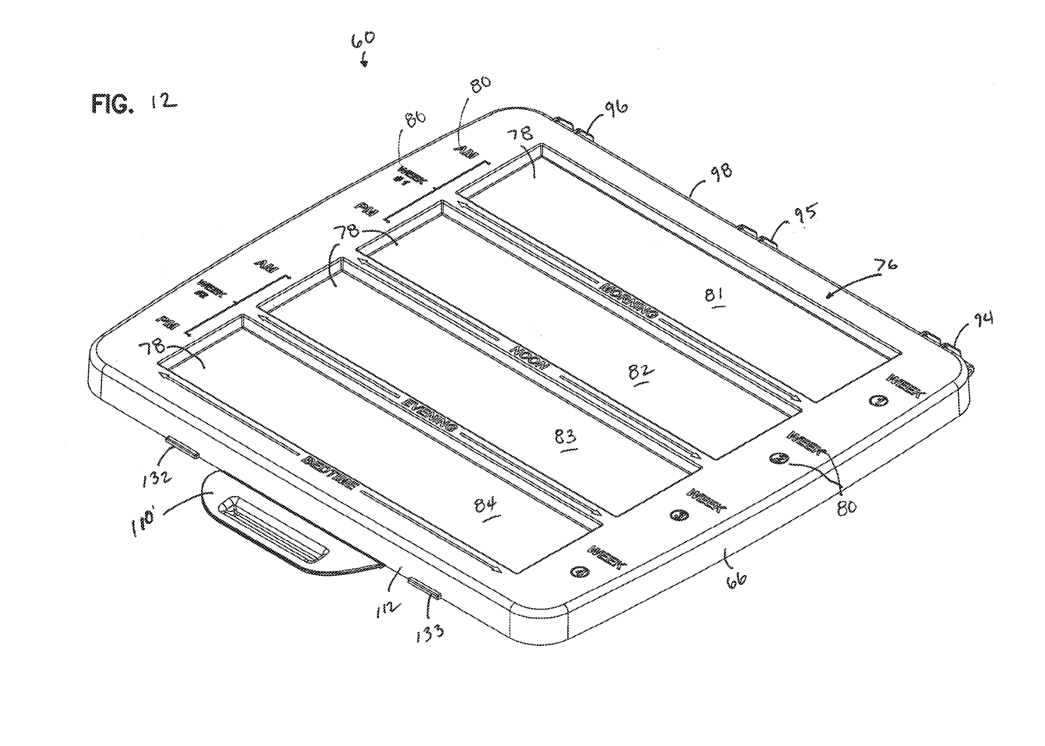

In the example embodiment shown, the lid snap latch arrangement 122 includes at least one, and preferably a pair of snap tabs 124, 125 extending or projecting from a remaining portion of the lid 70. In this example, the snap tabs 124, 125 extend from a front side 128 of the lid 70. The front side 128 is opposite the rear side 120. The snap tabs 124, 125 snap over the front side 112 of the cover 60. As can be seen in FIG. 12, the cover 60 includes a pair of projecting ribs 132, 133, extending from the front side 112. The ribs 132, 133 engage the snap tabs 124, 125 to help secure the lid 70 to the cover 60.

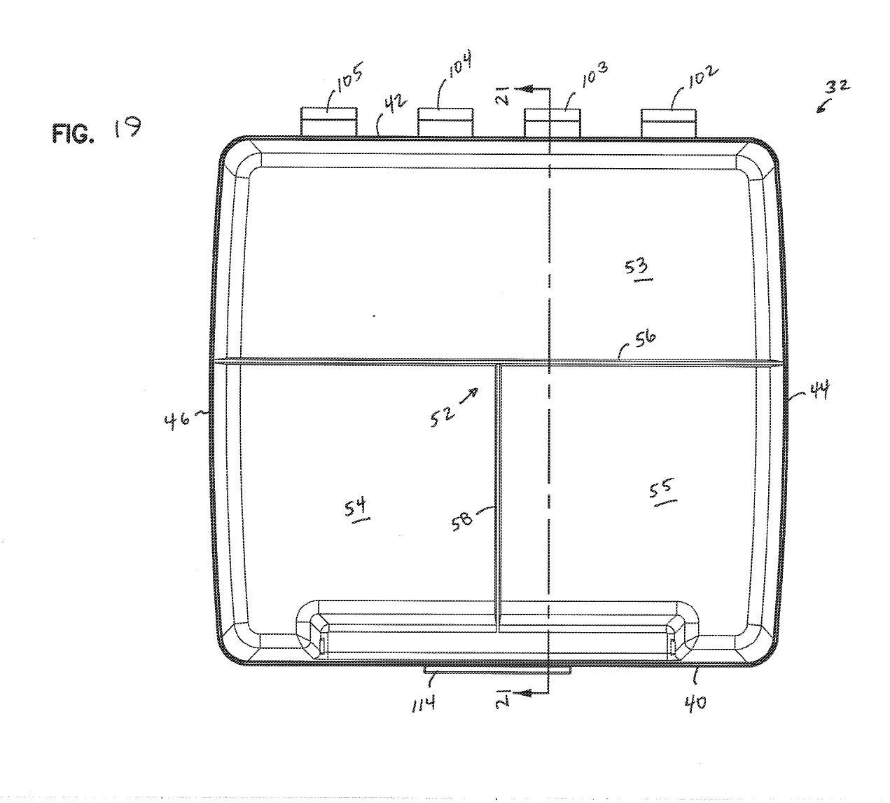

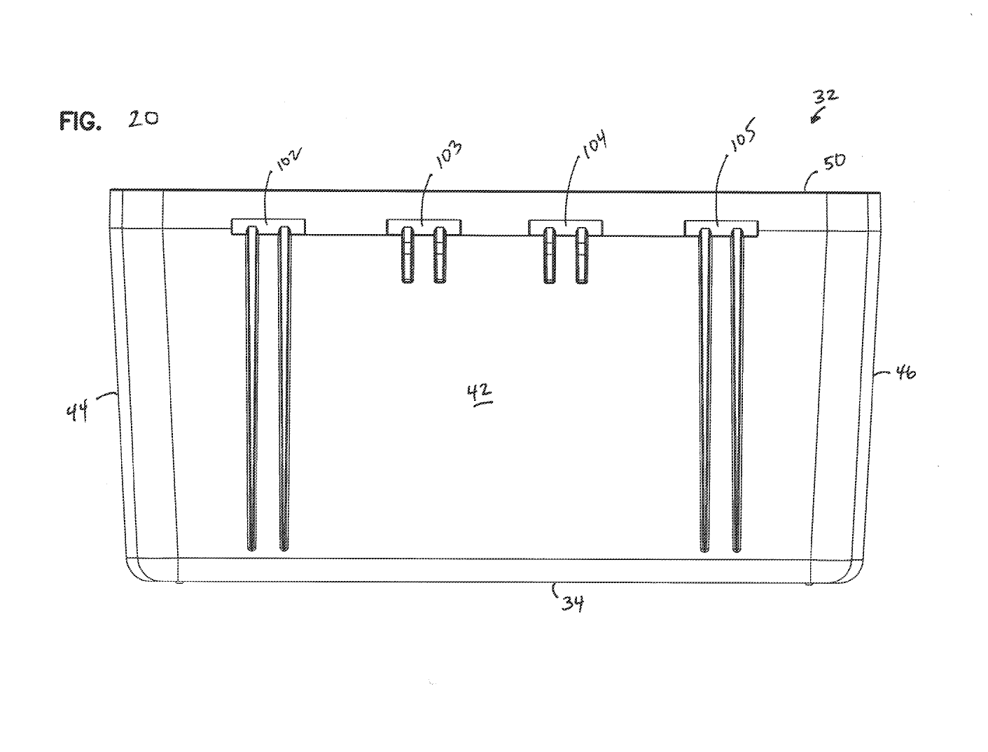

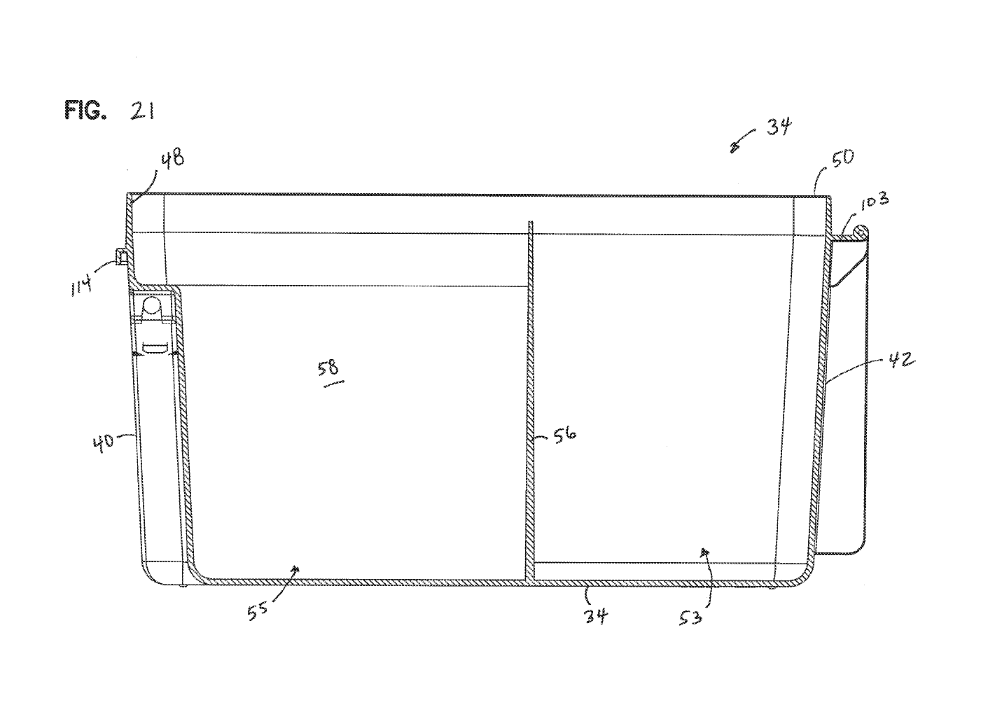

In reference now to FIGS. 19-21, the example embodiment of the base 32 is illustrated. The base 32 preferably has a size suitable for carrying accessories for use with taking medicine or pills. In the example shown, the base 32 has a depth, as measured between the rim 50 and the bottom 34 that is at least twice a depth of the cover 60 and lid 70 together. The base 32 can have a depth of, for example, at least 4 inches, including 5-10 inches. It can have a length as measured between first side wall 44 and second side wall 46 of at least 6 inches, for example 7-18 inches. The width between the front wall 40 and rear wall 42 can be at least 6 inches, for example 7-18 inches. While the material of the base 32 can vary, in one example embodiment, the base 32 is made from a hard plastic such as polypropylene. The base 32 can be made from either transparent or an opaque material.

A method of using the kit 30 can include a step of unlatching the lid 70 from the cover 60 and then pivoting the lid 70 away from the cover 60 to access the cover storage volume 65 and the contents of the storage volume 65. For example, the step can include accessing the pill container 68 held by the cover 60.

This step of unlatching the lid 70 from the cover 60 can include releasing the snap tabs 124, 125 from the ribs 132, 133 on the cover 60.

During the step of pivoting the lid 70, the lid 70 can be pivoted about the hinge member 94 to move the lid 70 from a position operably covering the cover 60 to a position in which the lid 70 is away from the cover 60, such as that shown in FIG. 1.

The method can include a step of unlatching the cover 60 from the base 32 and pivoting the cover 60 from the base 32 to access the storage volume 38 in the base 32.

The step of unlatching the cover 60 from the base 32 can include releasing the flange 110 on the cover 60 from the latch element 110 on the base 32. The cover 60 can then be pivoted about the hinge assembly 92 in order to move the cover 60 away from the base 32 and expose the opening 48 to provide access to the storage volume 38.

The step of pivoting the cover 60 from the base 32 can include also pivoting the lid 70. In some implementations of the method, the lid 70 will remain secured to the cover 60, while the cover 60 and lid 70 are pivoted while being secured together about the hinge assembly 92 from the base 32.

The method can include, after the step of unlatching a lid from a cover, re-securing the lid 70 to the cover 60 by engaging the snap tabs 124, 125 with the ribs 132, 133 on the cover 60. After the step of re-securing the lid 70 to the cover 60, then the cover 60 can be unlatched or released from the base 32 in order to rotate the cover 60 and lid 70 together relative to the base 32.

The method can include, after the step of pivoting the lid 70, opening the pill container 68 to access an interior of the pill container 68.

The method can include, after the step of pivoting the cover 60, from the base 32, removing accessories for use from the storage volume 38.

The method can include the step of securing the lid 70 to the cover 60, and securing the cover 60 to the base 32. After the lid 70 and cover 60 are secured, transporting the kit 30 by use of the handle 72. This step may include pivoting the handle 72 away from the remaining portion of the base 32 to allow for a person's hand to grasp the handle 72.

The above description provides examples and principles. Many embodiments can be made applying these principles.

What is claimed is:

1. A kit comprising:
(a) a base having a bottom, a surrounding wall extending from the bottom, a storage volume defined by the surrounding wall, and an opening opposite the bottom providing access to the storage volume;
(b) a cover removably secured to the base over the opening to provide selective covering and uncovering of the storage volume in the base;
(i) the cover having a base-facing side and an opposite holder-side; the base-facing side facing the storage volume, when the cover is operably positioned in covering relation on the base; and the holder-side facing away from the storage volume, when the cover is operably positioned in covering relation on the base;
(ii) the holder-side of the cover being constructed and arranged to removably hold at least one pill container therein; and
(c) a lid removably secured over the holder-side of the cover to provide selective access to the holder-side and the at least one pill container, when the pill container is positioned therein.

2. The kit of claim 1 wherein the holder-side of the cover is constructed and arranged to removably hold a plurality of pill containers therein.

3. The kit of claim 1 wherein the holder-side of the cover has a depression arrangement shaped to hold at least one pill container therein.

4. The kit of claim 3 wherein the depression arrangement is shaped to hold a plurality of pill containers.

5. The kit of claim 4 wherein the depression arrangement includes at least four recessed volumes, each recessed volume being constructed and arranged to hold a respective pill container.

6. The kit of claim 1 wherein the lid is transparent.

7. The kit of claim 1 further comprising a hinge assembly attaching the cover to the base.

8. The kit of claim 7 further comprising a cover snap latch arrangement to selectively secure the cover to the base.

9. The kit of claim 1 further comprising a hinge assembly attaching the lid to one of the cover or the base.

10. The kit of claim 9 further comprising a lid snap latch arrangement to selectively secure the lid to the cover.

11. The kit of claim 1 further comprising a handle.

12. The kit of claim 11 wherein the handle is pivotably secured to the base.

13. The kit of claim 1 wherein a depth of the base is at least twice a depth of the cover and lid together.

14. The kit of claim 1 further comprising a dividing wall arrangement in the storage volume.

15. The kit of claim 1 further comprising at least one pill container held by the cover in the holder-side of the cover.

16. The kit of claim 15 wherein the at least one pill container comprises at least one multiple compartment container.

17. The kit of claim 16 wherein there are 4 multiple compartment containers held by the cover in the holder-side of the cover, arranged in rows.

18. The kit of claim 15 wherein the holder-side of the cover has a depression arrangement holding the at least one pill container therein.

19. A method of using a kit, the method comprising:
(a) unlatching a lid from a cover and pivoting the lid away from the cover to access a pill container held by the cover; and
(b) unlatching the cover from a base and pivoting the cover from the base to access a storage volume in the base.

20. The method of claim 19 further comprising:
(a) after the step of pivoting the lid, opening the pill container to access an interior of the pill container.
